(19) United States
(12) Patent Application Publication
(10) Pub. No.: US 2005/0187663 A1
(43) Pub. Date: Aug. 25, 2005

(54) Maintenance method and device

(76) Inventors: Luder Heidemann, Erlangen (DE); Hansjurgen Seybold, Erlangen (DE)

Correspondence Address: SIEMENS CORPORATION;INTELLECTUAL PROPERTY DEPT., 170 WOOD AVENUE SOUTH, ISELIN, NJ, 08830, US

(21) Appl. No.: 10/670,929

(22) Filed: Sep. 25, 2003

Related U.S. Application Data
(63) Continuation of application No. PCT/DE02/01013, filed on Mar. 20, 2002.

(30) Foreign Application Priority Data
Mar. 29, 2001 (DE) 10115694.4
Sep. 27, 2001 (DE) 10147741.4

(51) Int. Cl. G05B 21/00

(52) U.S. Cl. 700/266

(57) ABSTRACT

A real process is simulated for preventively detecting the need for maintenance and the simulation is synchronized with the real process. Malfunctioning can be timely detected from a process control viewpoint by comparing the real process with the simulation and maintenance measures can be appropriately managed. Downtime in a facility can thus be reduced and individual process steps are optimized.

The present invention relates to a device and method for maintaining a system in which a real process is handled.

Necessary maintenance measures are generally carried out on an event-controlled or time-triggered basis. With event-controlled maintenance measures, a process component will be replaced or repaired if it has failed. In the case of time-triggered maintenance, on the other hand, maintenance measures are performed at regular intervals, the aim being to prevent outage of the process facility.

Preventive maintenance is of paramount importance especially where highly complex facilities are concerned: The outage, for instance, of a production facility can give rise to very high costs. That is why complex facilities are frequently monitored by sensors and the measurements used to detect a need for maintenance. This typically entails performing measurements on components of a facility and recording these measurements during the process. Changes in the measurements allow tendencies to be recognized that may necessitate maintenance measures. For example, pressure may rise in a facility over time, indicating a blocked pipeline, for instance. As further examples, vibrations may point to a worn bearing and measurements performed on the phase angle delta in a motor drive may indicate unfavorable drift. However, not in every facility can individual components be constantly monitored for wear and the like: Monitoring may be uneconomical in the case, for example, of very high process temperatures or facilities of very compact physical design, or if individual components are extremely complex.

The object of the present invention is thus to improve or expand the possibilities of detecting a need for maintenance in facilities and systems.

This object is achieved according to the invention by means of a method for maintaining a system by executing a real process in the system, by executing a simulation process synchronously with the real process, with the simulation process simulating at least a part of the real process, by comparing the simulation process with the real process or said part thereof, with a comparison result being obtained from this, and by deriving maintenance measures from the comparison result.

The above object is further achieved by means of a device for maintaining a system on which a real process with one or more real process steps can be executed, with a simulation device for simulating at least a part of the real process by means of a simulation process, the simulation process being executable synchronously with the real process, with a comparison device for comparing the simulation process with the real process with a comparison result being obtained, and with a control device for initiating a maintenance measure on the basis of the comparison result.

Production-driven maintenance can hence be advantageously facilitated by the invention, with the simulation of the process running in parallel with the real process. During this, the simulation process can be supplied with, for example, associated production parameters.

Further advantageous developments of the device according to the invention and of the method according to the invention can be found in the subclaims.

The present invention will now be described in more detail with the aid of the attached drawings, in which

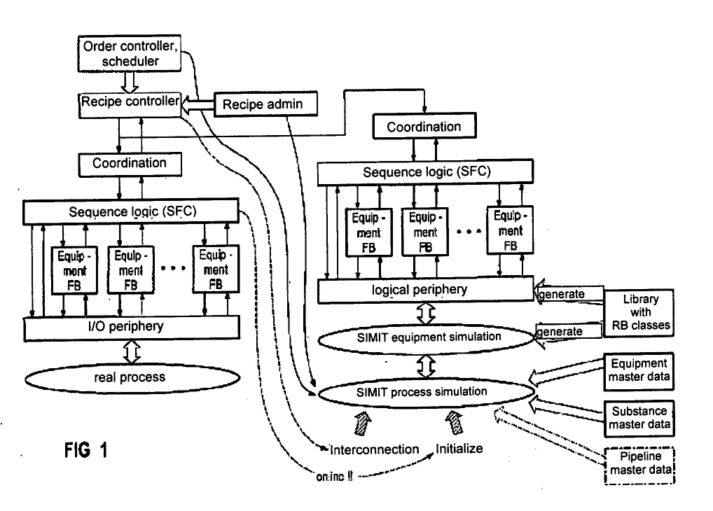

FIG. 1 shows a data flow diagram of a real process and a simulation process running in parallel according to the invention;

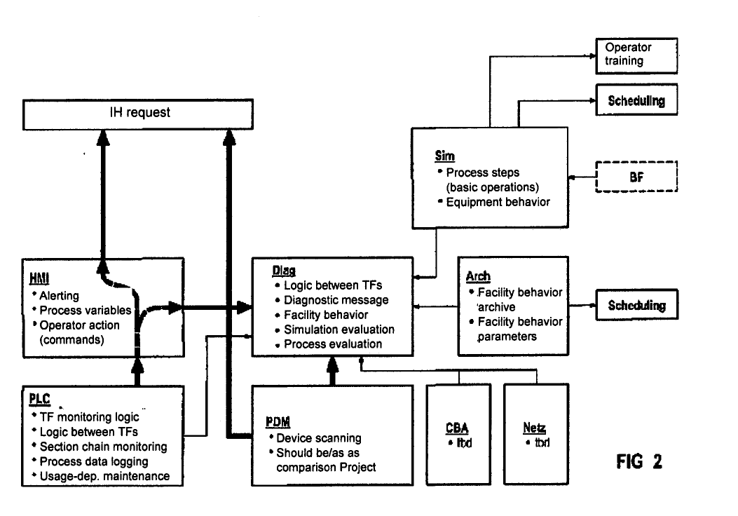

FIG. 2 shows a signal flow diagram for alerting and predicting a need for maintenance; and

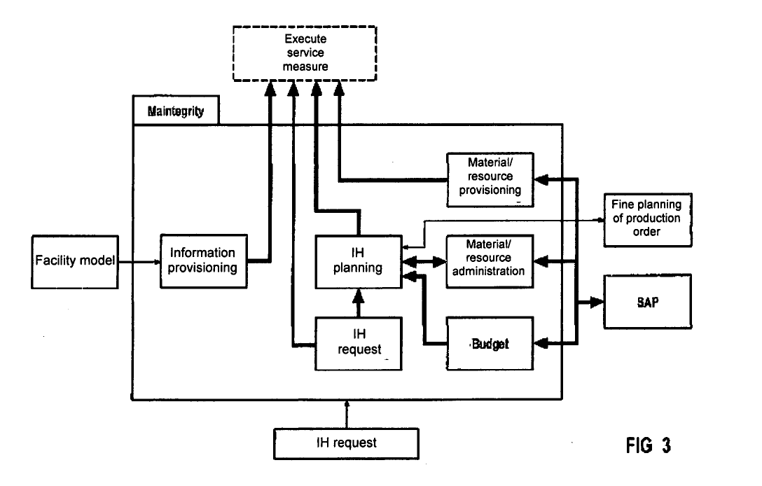

FIG. 3 shows a signal flowchart for implementing maintenance measures.

The exemplary embodiments described below show preferred embodiments of the present invention.

FIG. 1 shows, in its left half, a schematic signal flowchart of a control of a real process and, in its right half, that of a simulation process running in parallel. The order controller or what is called a scheduler serves as a starting point for controlling the real process. A recipe control (batch flexible) is driven with the order data. The recipe control obtains the required recipe(s) from a database, namely the recipe administration. This drive is suitable for both batch-processing processes (batch) and continuous processes.

Actual facility control or automation takes place in the block in FIG. 1 designated “sequence logic”. A separate component between the recipe control and sequence logic coordinates the instructions with regard to semantics.

The sequence logic is associated with several function blocks FB which are responsible for automating individual steps. Via an input/output periphery the sequence logic and function blocks then exchange instructions and measurements with the process components of the real process. A simple production process performed within a simplified facility could serve as an example of a real process. A container is linked to a reactor via a pipe. The reactor contains two generating sets, a mixer, and a heater set. The container is filled with a certain substance. During the production process the reactor could first be filled with the substance from the container then heat and mix said substance. The relevant process steps are filling, heating, and mixing. Each of these individual process steps or basic operations has its own internal sequence of instruction steps which is implemented in the sequence logic. The process step ‘fill’ may, for example, comprise the instructions: Check status of cellular wheel sluice, open slide gate, check fill level etc. In a recipe for producing a certain substance the individual process steps are precisely specified. Similar to a cooking recipe, the control recipe contains parameters such as process times, process temperatures etc. A set sequence of process steps is also specified.

The individual process steps are sequenced in the sequence logic and the respective start and end time specified. Facility components are individually controlled by function modules as directed by the sequence logic.

A corresponding simulation process is shown on the right-hand side of the figure in FIG. 1. Like the real process system, the simulation system consists of a coordination module followed by the sequence logic and equipment function modules. The input/output periphery of the real process is simulated by a logical periphery. The real process itself must be simulated, on the one hand, in its components and, on the other hand, in the process flow itself. The components are simulated in what is called an equipment simulation, and the equipment simulation modules are suitably linked together for the process simulation.

The logical periphery and equipment simulation can be generated automatically by a semantics manager from a library of RB classes (reaction modules).

Equipment master data, substance master data, and pipeline master data etc. flow into the process simulation. Equipment master data comprises, for example, the diameter of containers, features of valves, pumps etc. Substance master data comprises quantities, grain size distribution etc. of the substance used. Lastly, the pipeline master data corresponds to dimensions and other relevant variables of the pipelines used. All the master data can be filed in libraries.

According to the invention the real process is then synchronized with the simulation process. The two processes consequently run in parallel so as to make a direct comparison of the process results possible. It is not necessary here to simulate the entire real process; instead, a particularly critical process step, for example, can be simulated which requires, for instance, constant monitoring.

The process simulation is favorably co-controlled by the order controller of the real process. It is, however, also possible to provide a separate control for the simulation. Moreover, the process simulation preferably obtains the recipes from the recipe administration of the real process. This direct linking to the real process is one of the prerequisites for automatic engineering of the simulation. In any event it is definitely helpful for this.

The simulation allows the entire facility and/or major parts of it to be simulated as a virtual facility. Selectively simulating parts of the facility and comparing the relevant virtual and real process steps allow the need for maintenance to be localized to a degree commensurate with the size of the simulation component. For example, critical parts of the facility can be subdivided into finer process steps in order better to localize the need for maintenance. Where non-critical parts of the facility are concerned, several components can be combined both during measuring of the real process and during the simulation. If a fixed deviation or a deviation increasing with time is then detected on the basis of the comparison of the results of process steps in the real and virtual process, appropriate maintenance measures can be initiated.

According to the invention the behavior of a facility from a process control viewpoint is examined so that a need for maintenance can be detected in a timely fashion. This means that, for example, the vibrating of a pump is not measured so that conclusions can be drawn about a worn bearing; instead, the flow through the pump is measured and compared with a simulated ideal flow so that the pump's aging can be detected.

In a development of the invention it would also be possible to simulate the behavior of the substance which is contained within the facility and being processed. Conclusions could be drawn about the facility from the simulated and real chemical conversion-process. For example, deviations in a substance's physical state, such a viscosity, could indicate a defective cooling device. Equally, differences between the simulated and measured PH value, for instance, could indicate a defective mixer.

Whether the physical parameters of the substance located within the facility or typical variables of the facility, such as the throughput rate, are used for diagnostic purposes, is of secondary importance provided the simulation process runs, according to the invention, in parallel with the real process and individual results of process steps or overall results of the process as a whole are compared. For the respective comparison it is necessary for the start and end of each process step being compared to be defined and recognized. Unique indicators for a need for maintenance can also be determined. For example, unusually long filling times or excessive heating times can be recognized that deviate from normal facility operation. These differences do not necessarily result in an outage of the entire facility or the production of rejects; they may merely indicate that the facility is not running according to the planned optimum.

Appropriate maintenance measures can be carried out in keeping with the magnitude of the deviations. Simply a warning can be directed to the maintenance team if there is only a slight difference between the real and simulated process. In the case of major differences a fault message can be issued signaling an immediate need for maintenance.

The diagnostic information obtained from parallel running of the real and simulated process can also be used to optimize the facility. If, for example, the facility is run using a changed recipe, the process steps and/or their sequence will also change. The facility controller or scheduler converts the new recipe into time flows or time slices. In the case of multi-substance facilities, for example, these time slices must be coordinated as a function of the different substances and facility components. The aim here is to utilize all parts of the facility to optimum capacity. To improve scheduling online, the simulation process can run in parallel with the real process. Optimization can thereby be achieved without the need for the facility to be idle.

As already mentioned, a meaningful comparison between real and simulated process steps requires precise synchronizing. A precise starting point must also be specified, which is done by initializing. As indicated in FIG. 1 by a broken line, initializing of the simulation process can be controlled online by the sequence logic of the original facility. For example, it is possible to ensure that a container in the original facility and in the simulation has in each case a defined fill level at a specific process step in a specific recipe.

The single arrows in FIG. 1 signify signal links or action links, and the double arrows signify data connections which are necessary for, for example, parameterizing and engineering.

FIG. 2 shows a schematic signal flowchart for obtaining a maintenance request on the basis of the diagnosis resulting from the comparison between the real process and simulation process running in parallel. Explanations of the modules can be found in the table at the end of the description.

FIG. 3 shows a signal flowchart showing further processing of a maintenance request in a maintenance management system. According to this, service measures are performed if necessary on the basis of information provisioning, material/resource provisioning, maintenance planning, and the maintenance request. Material/resource administration and the budget have an impact here on maintenance planning. The facility model also serves for information provisioning.

TABLE

| Component | Function | Task |
|---|---|---|
| PLC | Logic in TF | Suppression of follow-up |
| | | message. |
| | | Example 1: Outage of the |
| | | alerting voltage (simultaneously) |
| | | takes all the |
| | | messages from the monitoring |
| | | loop fed by the |
| | | alerting voltage (“contacts”). |
| | | Example 2: All messages |
| | | must be suppressed in |
| | | on-site operation (from |
| | | a repair counter). |
| | | Module message |
| | | Example 1: Check-back |
| | | monitoring (protective |
| | | check-back, rotation |
| | | speed check-back, operating |
| | | time message) |
| | | Example 2: Operating |
| | | mode changeover |
| | Process data logging | Make process values |
| | | available that are required |
| | | for cross-area |
| | | logic (event-triggered, |
| | | in the case of measurements |
| | | for change with |
| | | dead band) |
| | Logic between TFs | Technological monitoring |
| | | of a PLT location. |
| | | Example 1: A jump in |
| | | setpoint value on a |
| | | regulator must result a |
| | | rise in the actual |
| | | value. |
| | | Example 2: Manipulated |
| | | variable of a regulator |
| | | increases with no change |
| | | in the setpoint value |
| | | (wear on valve seating). |
| | | Example 3: Pressure or |
| | | flow measurement on pump |
| | | group |
| | Usage-dependent | Operating cycle/ |
| | maintenance | operating time |
| | | counter |
| | | Count the operating |
| | | hours or operating cycles, |
| | | generate IH request |
| | | if a parameterized |
| | | threshold is exceeded |
| | Section chain | Time monitoring for indexing |
| | monitoring | condition |
| PDM | Scan field devices | Information from intelligent |
| | | field devices |
| | | PDM (AMS) scans the accessible |
| | | field devices |
| | | and transfers messages |
| | | (selected by parameterizing) |
| | | Live monitoring of intelligent |
| | | field devices |
| | | PDM (AMS) scans the |
| | | planned field devices |
| | | and generates a message |
| | | if a planned device cannot |
| | | be accessed. |
| | Should be/as | Comparison planning - |
| | is comparison | as is |
| | project | PDM (AMS) scans the accessible |
| | | field devices |
| | | and generates a message |
| | | if planning is not as is |
| | | (read field device not |
| | | in the project). |
| CBA | | |
| CM | Condition monitoring | Example 1: Vibration |
| | | monitoring on machine |
| | | Example 2: Electrical |
| | | fingerprint for motor |
| | | Example 3: HISS (smell, |
| | | hear, taste) |
| HMI | Operation of operating | Example: “Standard deviation” |
| | or recipe parameters | parameter for |
| | | fault message dependent |
| | | on operating mode |
| | Alarms | Planned alarms = IH request |
| Diag | Facility behavior | Comparison of current |
| | | facility behavior with |
| | | history. |
| | | Example 1: How long has |
| | | it taken so far to bring |
| | | material x in unit y |
| | | from m to n fill height? |
| | | Comparison with current |
| | | step. |
| | | IH request via user action |
| | | with GUI support. |
| | | User generates IH request |
| | | Necessary: Facility behavior |
| | | archive or (at |
| | | least) parameterized |
| | | comparison values |
| | Logic between TFs | Technological monitoring |
| | | of part of a facility |
| | | Logic or rules on a |
| | | cross-area basis over |
| | | several PLT locations |
| | | (on several PLCs, where |
| | | applicable) |
| | Diagnostic message | Message frequency |
| | | Example 1: Specific report |
| | | numbers from a specific |
| | | TP are (interactively) |
| | | “set to diagnosis” |
| | | and continuously |
| | | monitored from then on |
| | | until a suspected fault |
| | | cause has been recognized/ |
| | | analyzed. |
| | | Example 1: Suspicion of |
| | | increased outage rate of |
| | | a motor drive: The report |
| | | numbers, protective |
| | | check-back, and bimetal |
| | | message generate a diagnostic |
| | | message if more |
| | | than 5 messages occurred |
| | | per shift. |
| | Simulation evaluation | Compare the result of |
| | | process/equipment simulation |
| | | with real process/ |
| | | facility results. |
| | | Decision rules specifying |
| | | when a comparison |
| | | between simulation result |
| | | and as-is facility |
| | | is ok/not ok and (in |
| | | the case of process |
| | | simulation) assignment |
| | | to asset. |
| | Behavior evaluation | Compare value from facility |
| | | behavior archive |
| | | or from facility behavior |
| | | (with fixed values |
| | | determined in IBS/trial |
| | | operation) with real facility |
| | | results. Otherwise |
| | | as above. |
| | | Note: |
| | | Simulation evaluation is |
| | | advantageous in the case |
| | | of multi-purpose facilities |
| | | where a meaningful |
| | | facility behavior archive |
| | | is not ensured on |
| | | account of the multiplicity |
| | | of products/ |
| | | recipes. |
| | | Behavior evaluation is |
| | | advantageous in the case |
| | | of “single-purpose” facilities |
| | | and conti-/ |
| | | semiconti facilities. |
| Sim | Process simulation | Technological monitoring |
| | | of recipe steps |
| | | SIMIT has models of the |
| | | facility GOs (mix, heat, |
| | | fill etc.). Each individual |
| | | model has parameters |
| | | (substance, unit, |
| | | and product parameters). |
| | | The simulation runs under |
| | | BF control (BF gives |
| | | the step start, with the |
| | | parameter set valid for |
| | | the step and the end |
| | | criterion (e.g. final |
| | | temperature 92° C.), to |
| | | SIMIT. SIMIT starts |
| | | simulation and, on attainment |
| | | of the end criterion, |
| | | gives the result |
| | | parameter set defined |
| | | for the GO to Diag. |
| | | SIMIT has (as yet) no |
| | | command of substance |
| | | conversions; operations |
| | | of this type (e.g. “reaction”, |
| | | “synthesis”) |
| | | have to be simulated by |
| | | simple empirical equations |
| | | if a pass is to be |
| | | made through several GOs |
| | | in a “simulation chain”. |
| | | No project-specific engineering |
| | | work is necessary |
| | | because this method |
| | | runs under the control |
| | | of BF. SIMIT “only” |
| | | needs models that are |
| | | process/project neutral. |
| | Equipment behavior | Technological monitoring |
| | | of the equipment behavior |
| | | SIMIT has models of the |
| | | (technological) equipment |
| | | behavior (e.g. resistance |
| | | heating element |
| | | with time behavior, heat |
| | | transition, heat flow in |
| | | the substance etc.). |
| | | Otherwise analogous to |
| | | the above |
| Arch | Facility behavior | History of the product- |
| | archive | and substance-/material- |
| | | dependent time behavior |
| | | of parts of the facility, |
| | | units, equipment, |
| | | and also relevant |
| | | (fixed) parameters. |
| | | Different embodiments |
| | | for the process industry |
| | | and discrete (manufacturing) |
| | | industry: |
| | | Process industry: Objects |
| | | are steps in the |
| | | flow such as filling, |
| | | heating etc. and equipment |
| | | (S 88), not the objects |
| | | of the facility |
| | | model such as a pump, |
| | | regulating valve etc. |
| | | Discrete industry: Objects |
| | | are the “machines” |
| | | of the facility model. |

1. A method for maintaining a manufacturing system by executing a real process in the system, comprising:
executing a simulation process parallel to the real process, the simulation process simulating at least a part of the real process;
comparing at least a portion of the simulation process with at least a portion of the real process to obtain a comparison result; and
deriving maintenance measures from the comparison result.

2. A method according to claim 1, wherein the real process is executed with the simulation process during the parallel execution.

3. A method according to claim 1, wherein the simulation process and real process each comprise several steps and wherein one of the steps in each case is compared with the other for the purpose of deriving the maintenance measures.

4. A method according to claim 1, wherein the comparing uses end results of the real process and simulation process partial results from one or more steps of the real process and simulation process.

5. A method according to claim 1, wherein the real process and simulation process are controlled jointly by a single control device.

6. A method according to claim 1, wherein a maintenance measure is an alarm or activation of a maintenance system.

7. A method according to claim 1, wherein a simulation process structure is automatically generated from a real process structure.

8. A method according to claim 1, wherein the simulation process is supplied with substance or production parameters from the real process.

9. A device for maintaining a system on which a real process with one or more real process steps can be executed, comprising:
a simulation device for simulating a part of the real process by a simulation process, wherein the simulation process is executed synchronously with the real process;
a comparison device for comparing the simulation process with the real process, with a comparison result being obtained from the comparison; and
a control device for initiating a maintenance measure on the basis of the comparison result.

10. A device according to claim 9, wherein the simulation process in the simulation device can be is synchronized with the real process.

11. A device according to claim 9, wherein the simulation process and real process in each case comprise several steps and wherein one of the steps in each case is compared with the other in the comparison device.

12. A device according to claim 9, wherein comparing is carried out in the comparison device using end results of the real process and simulation process or partial results from one or more steps of the real process and simulation process.

13. A device according to claim 9, wherein the real process and simulation process are controlled jointly by a single control device.

14. A device according to claim 9, which is embedded in a maintenance system.

15. A device according to claim 9, wherein a simulation process structure is automatically generated from a real process structure.

16. A device according to claim 9, wherein the simulation device is supplied with production parameters from the real process.

17. A method according to claim 2, wherein the simulation process and real process each comprise several steps and wherein one of the steps in each case is compared with the other to derive maintenance measures.

18. A method according to claim 2, wherein the real process and simulation process are controlled jointly by a single control device.

19. A device according to claim 10, wherein the simulation process and real process comprise several steps and wherein one of the steps in each case is compared with the other in the comparison device.

20. A device according to claim 10, wherein the real process and simulation process is controlled jointly by a single control device.

21. A method according to claim 4, wherein the comparing uses end results or partial results related to at least one process-control-related variable.

22. A device according to claim 12, wherein the comparing uses end results or partial results related to at least one process-control-related variable.

23. A method according to claim 7, wherein a generic simulation model is used to generate the simulation process structure.

24. A device according to claim 15, wherein a generic simulation model is used to generate the simulation process structure.
